(19) United States
(12) Patent Application Publication
(10) Pub. No.: US 2005/0036170 A1
(43) Pub. Date: Feb. 17, 2005

(54) Image processing apparatus and image forming apparatus

(75) Inventors: Takanori Okuoka, Ebina-shi (JP); Kouichi Kawahara, Ebina-shi (JP); Mari Kodama, Ebina-shi (JP); Satoshi Yoshikawa, Ebina-shi (JP); Kazunori Kurokawa, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/796,138

(22) Filed: Mar. 10, 2004

(30) Foreign Application Priority Data
Aug. 11, 2003 (JP) 2003-291410

(51) Int. Cl. G06K 15/02; G06F 9/44; G06F 3/12

(52) U.S. Cl. 358/1.16; 358/1.18; 717/106

(57) ABSTRACT

An image processing apparatus and an image forming apparatus are characterized in that appropriate settings can be smoothly performed, and a connected job can be edited without losing an original print job. The memory stores a job including image data or drawing data output from an image processing terminal and a print setting condition, and an image processing component performs predetermined image processing to the job. A job connection component sets connection information for connecting plural jobs stored in the memory and a print setting condition of the connected job, and a print process execution component executes a print process of the connected job on the basis of the connection information and the print setting condition.

### CROSS-REFERENCE TO RELATED APPLICATION

This application claims priority under 35USC 119 from Japanese Patent Application No. 2003-291410, the disclosure of which is incorporated by reference herein.

### BACKGROUND OF THE INVENTION

1. Field of the Invention

The present invention relates to an image processing apparatus and an image forming apparatus which perform image processing based on a job such as a print job, and to, an image processing apparatus and an image forming apparatus which can connect spooled jobs.

2. Description of the Related Art

DTP (Desktop Publishing) has become established as a form of digitalization in the field of printing processing. In DTP, an image is formed, processed, and edited by using various applications on a processing apparatus such as a personal computer or a workstation to form a page layout, and a film for exposing a printing plate on the basis of the page layout is formed (CEPS), or writing is directly performed on the printing plate to form a machine plate for printing (CTP: Computer to Plate).

In DTP, a separation process for separating an image on the page layout into colors, i.e., Y, M, C and K is performed to expose the printing plate on the basis of image data of each color, thereby forming a machine plate on which a halftone image is formed.

On the other hand, prior to printing using an actual machine plate, proofreading may be performed. At this time, a page layout is displayed on a monitor or printed out by a printing output device such as a laser printer or a page printer using a WYSIWYG function or the like.

In an application for DTP, forming, processing, editing, and the like of an image are performed to form a page layout with color information. However, when carrying out a printing process using a machine plate, the image must be separated into ink components of colors, i.e., C, M, Y, and K, to form a machine plate. On the basis of the machine plate, the image must be separated into C, M, Y, and K colors by using the application for DTP or an image processing apparatus called a RIP (Raster Image Processor) and having a function of converting image data or a drawing instruction into bitmap data to print out a page.

Some of such image processing apparatuses include a function of holding print jobs which are spooled. In this manner, plural spooled print jobs can make it possible to print out pages at a desired timing.

Various print settings must be performed when the print jobs are united, and operations for the print jobs are cumbersome. When an erroneous print setting is performed, a warning or the like is generated to notify a user of the erroneous print setting, and a setting operation that is thought to be correct must be performed.

When image data or the like of a united print job is generated and held, an amount of data to be spooled increases unless original print jobs are deleted. However, in a case where the original print jobs are deleted, when editing to delete a print job from the united print job is performed, there is a problem in that data of the print job which is deleted due to the editing is lost.

### SUMMARY OF THE INVENTION

The present invention has been made in consideration of the above circumstances, and provides to propose an image processing apparatus and an image forming apparatus which can smoothly perform an appropriate setting when print jobs are connected to each other and which can smoothly edit a connected job without losing an original print job.

The invention provides an image processing apparatus having a memory which stores a job including image data or drawing data output from an image processing terminal and an image processing setting, and an image processing component which performs a predetermined image processing to the job stored in the memory, including a job connection component in which plural jobs stored in the memory are selected and instructed to generate a connected job so that connection information for connecting the jobs and an image processing setting of the connected job are generated, and the connection information and the image processing setting are stored in the memory as the connected job.

According to the invention, jobs to be connected are selected from jobs stored in the memory to generate a connected job.

At this time, the job connection component generates an image processing setting for the connected job, generates connection information for specifying jobs to be connected, a connection order, and the like, and stores the connection information and the image processing setting as a connected job in the memory while the selected jobs are left in the memory.

In this manner, a data amount of the connected job stored in the memory can be reliably prevented from increasing. When the connected job is output from the memory, it is sufficient to output the image processing setting and jobs selected on the basis of the connection information.

In the invention, the job connection component may include a generation component which generates image data of the connected job based on the image data of the plurality of selected jobs, and the job connection component may include a deleting component which deletes the plurality of selected jobs from the memory.

According to the invention, the image data of the connected job can be generated, and the selected jobs can be deleted from the memory. In this manner, unnecessary jobs can be prevented from being left in the memory.

In the invention, the image processing apparatus can include an editing component which deletes a selected job or adds a new job from/to the connected job generated by the job connection component and stored in the memory.

In the invention, the connection information is generated, the selected jobs are left in the memory as original jobs, and the connection information is changed, so that editing such as addition, deletion, or the like of jobs constituting the connected job can be easily performed. Since the original jobs are left, even though jobs are deleted from the connected job, the original jobs can be reliably prevented from being lost.

When a change (editing) is performed to delete the original jobs in the memory without generating the image data of the connected job, a warning or the like is preferably generated to urge a user to confirm the change.

Furthermore, the image processing apparatus may include a storage component which stores the image processing setting for the preset connected job as a common setting, the job connection component may select the common setting stored in the storage component as the image processing setting of the connected job, and the common setting stored in the memory may include common setting items applied to the plurality of jobs to be connected.

According to the invention, as the image processing setting of the connected job, the common setting stored in the storage component in advance is used. For the common setting, the common setting items commonly applied to the jobs to be connected are set. In this manner, the image processing of the connected job can be smoothly and properly set.

The image processing apparatus according to the invention may include a detection component which, when a job stored in the memory is selected, detects whether a password is set for the job or not. When it is detected by the detection component that a password is set, and, when a password which coincides with the password set for the job is input, the job connection component may be set the job as a job to be connected.

In the invention, when the selected jobs include a job for which a password is set, the job connection component may set a password for a connected job to be generated.

According to the invention, when security is set for a job selected as a job to be connected, the job can be selected as a job to be connected only when the security has been canceled. When the jobs to be connected include a job for which security is set, security is also set for the connected job.

For this reason, the security property of a job for which security is set can be reliably prevented from being lost.

A first aspect of the invention is to provide an image processing apparatus comprising: a memory that stores a job including image data output from an image processing terminal and an image processing setting; an image processing component that performs predetermined image processing to the job stored in the memory; a job connection component that sets connection information for connecting plural jobs and a print setting condition of a connected job when the jobs stored in the memory are selected and generation of the connected job is instructed; and a print process execution component which executes a print process of the connected job based on the connection information and the print setting condition set in the job connection component.

A second aspect of the invention is to provide an image forming apparatus comprising: a memory that stores a print job including image data output from an image processing terminal and a print setting condition; an image processing component that performs predetermined image processing to the print job stored in the memory; a print job connection component that sets connection information for connecting plural print jobs and a print setting condition of a connected job by selecting the print jobs stored in the memory and instructing generation of the connected job; and a print process execution component that executes a print process of the connected job on based on the connection information and the print setting condition set by the print job connection component.

As described above, according to the invention, when a connected job is generated, selected jobs are left in the memory, and an image processing setting and connection information of the connected job are generated and stored in the memory. In this manner, when the connected job is generated, an amount of data stored in the memory can be prevented from increasing.

In the invention, since original jobs are left in the memory when a connected job is generated, advantages that the connected job can be easily edited and that the original jobs can be reliably prevented from being lost are achieved.

### BRIEF DESCRIPTION OF THE DRAWINGS

Preferred embodiments of the present invention will be described in detail based on the following figures, wherein:

FIG. 1 is a schematic diagram of a print server applied to an embodiment of the present invention;

FIG. 2 is a functional block diagram showing an outline of job connection in the print server;

FIG. 3 is a flow chart showing an outline of formation of a common setting;

FIG. 4 is a schematic diagram showing an example of a user interface for forming the common setting;

FIG. 5 is a table showing an example of print options on a page tab;

FIG. 6 is a table showing an example of print options on a color tab, a delivery designation tab, and an output designation tab;

FIG. 7 is a table showing an example of print options on an image-quality tab and a graphics tab;

FIG. 8 is a flowchart showing an outline of job connection applied to the first embodiment of the present invention;

FIG. 9A is a schematic diagram showing an example of a job list before job connection;

FIG. 9B is a schematic diagram showing an example of a job list after job connection;

FIG. 10 is a schematic diagram showing an example of a user interface for registering a connected job;

FIG. 11 is a schematic diagram showing the configuration of a print job and a connection job in a spool;

FIG. 12 is a schematic diagram showing an example of a user interface for editing a connection job; and

FIG. 13 is a flow chart showing an outline of job connection according to the second embodiment of the invention.

### DETAILED DESCRIPTION OF THE INVENTION

An embodiment of the present invention will be described below with reference to the accompanying drawings.

[First Embodiment]

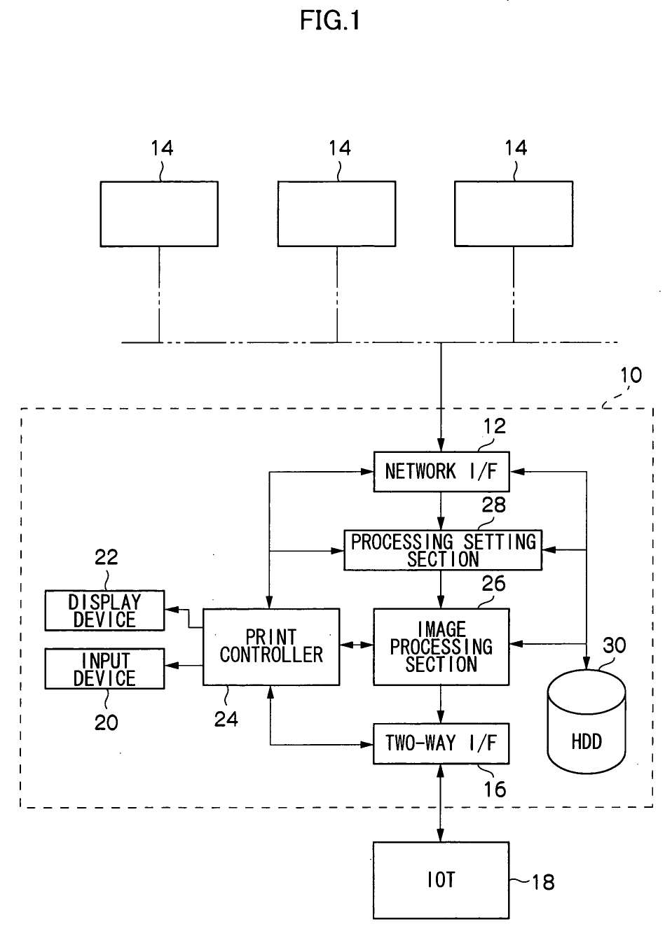

FIG. 1 shows a schematic configuration of a print server 10, which is applied as an image processing apparatus to the embodiment. A network interface (network I/F) 12 is arranged in the print server 10. Plural client terminals 14 such as personal computers or the like are connected to each other as image processing terminals through the network I/F 12.

In this manner, a print job or the like can be transmitted from each of the client terminals 14 to the print server 10. An arbitrary one of various network connections can be applied as the connection between the print server 10 and the client terminal 14.

A two-way interface (two-way I/F) 16 is arranged in the print server 10. A printer 18 serving as a printing output device (IOT) is connected to the print server 10 through the two-way I/F 16. As the print server 10, a print server to which plural printers 18 are connected may be used. However, in this embodiment, as one example, one printer 18 is illustrated.

The print server 10 includes an input device 20 such as a keyboard or a mouse and a display device 22 such as a CRT or a liquid crystal display to make it possible to perform display of various operation states or a user interface and an input operation of various pieces of information based on the display. The print server 10 can include a WYSIWYG function which processes an image displayed on the display device 22 and which prints out the display image.

As the print server 10 can be constituted by arranging a PCI board having a predetermined function in a personal computer (PC)

In the print server 10, a print controller 24 which controls the print server 10 itself and controls the operation of the printer 18 and an image processing section 26 which performs various image processings and a RIP process for forming raster data from image data are arranged. In addition, in the print server 10, a processing setting section 28 which perform various processing setting and print settings on the basis of a process instruction in a print job input from the client terminal 14 and a HDD 30 serving as a storage medium which can temporarily store the print job or the like input from the client terminal 14 together with various data for executing various programs, image processings, and print processes are arranged.

In the client terminal 14, image processings such as forming, processing, editing, and the like of an image, document formation, and the like are performed by using various application to make it possible to form image data or drawing data. The formed image data and a process instruction to the image data are designed to be output to the print server 10 as a process job such as a print job. At this time, for example, the print job is transmitted together with a job ID for specifying the print job.

As described above, the print server 10 comprises a general configuration which, when the print job transmitted from the client terminal 14 is received, executes an image processing based on the print job and prints out an image from the printer 18. In this embodiment, descriptions of the print server 10 and general processes using the print server 10 will be omitted.

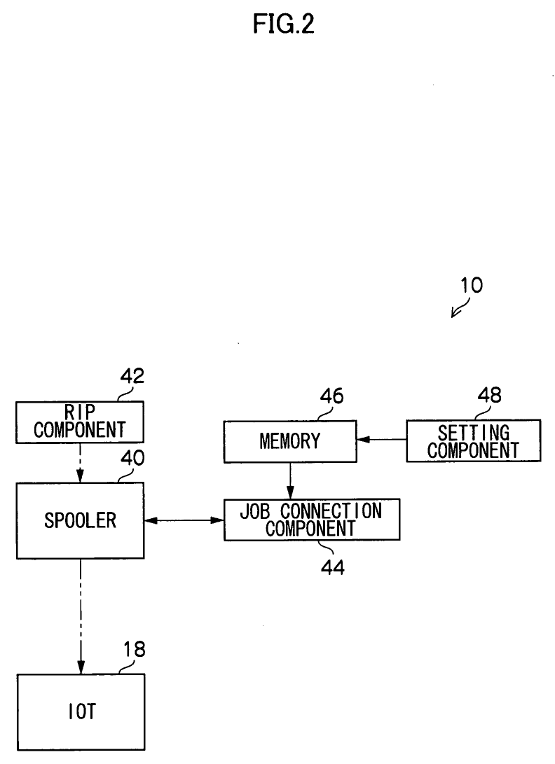

As shown in FIG. 2, in the print server 10, a spooler 40 serving as a memory which temporarily holds (spools) a job such as a print job is formed by using the HDD 30 (see FIG. 1). In the spooler 40, process jobs (to be referred to as print jobs hereinafter) such as a print job input from the client terminal 14 are subjected to a RIP process by a RIP component 42 and sequentially stored to designate processes (print processes) so that the print jobs are output to the printer 18 in a predetermined order such as an order of storage.

In the print server 10, when the client terminal 14 transmits a print job, when holding of the print job is set, the print job is designed to be held in the spooler 40. At this time, the spooler 40 is designed to store a drawing code (to be simply referred to as image data hereinafter) obtained by performing a RIP process to image data and image processing settings which are settings to a print job ID for specifying a print job and various print options.

The print job held in the spooler 40 can be displayed as a job list of the display device 22. While the job list is displayed on the display device 22, printing processing or the like can be executed by an input operation using the input device 20.

On the other hand, in the print server 10, a connection component 44 is formed. In this connection component 44, a print job held in the spooler 40 is selected, and a connection setting is performed, so that plural jobs are connected to each other to generate one job (to be referred to as a connected job hereinafter).

At this time, the connection component 44 generates connection information such as plurality of selected print jobs and a connection order of print jobs to hold the connection information in the spooler 40.

In this manner, in the print server 10, print jobs to be connected are left, and the connected jobs are substantially held in the spooler 40 without holding the image data of the generated connected job.

In the print server 10, a memory 46 which stores an image processing setting used in job connection and a setting component 48 for an image processing setting.

In the print server 10, an image processing setting for the connected job is formed and registered by the setting component 48 in advance, and the image processing setting is stored in the memory 46 as a common setting for the connected job. In the print server 10, plural common settings are designed to be registered and stored in the memory 46. In the job connection, a desired common setting can be selected from the registered common settings stored in the memory 46.

In the print server 10, when job connection is performed by the connection component 44, an image processing setting of the connected job can be performed by using the common setting stored in the memory 46.

In this manner, the connected job held in the spooler 40 is designed to constitute by only the connection information and the common setting.

On the other hand, in the print server 10, in the common setting used in connection of plural jobs, regardless of image processing settings of respective print jobs, common setting items applied to the image processing setting of the connected job are designated and stored in the memory 46. The common setting is set such that the common setting items are selected as predetermined conditions in advance.

The registration of the common setting on the print server 10 can be performed by a user interface having an arbitrary configuration.

As an operation of the first embodiment, registration of a common setting will be described first.

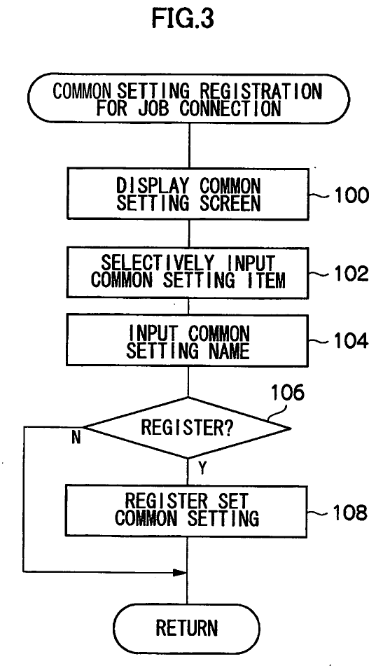

FIG. 3 shows an outline of registration of a common setting. This flow chart is executed by selecting registration of a common setting on the print server 10. In the first step 100, a user interface for a common setting is displayed on the display device 22. At Step 102, the settings of the common setting items are selected and input on the user interface.

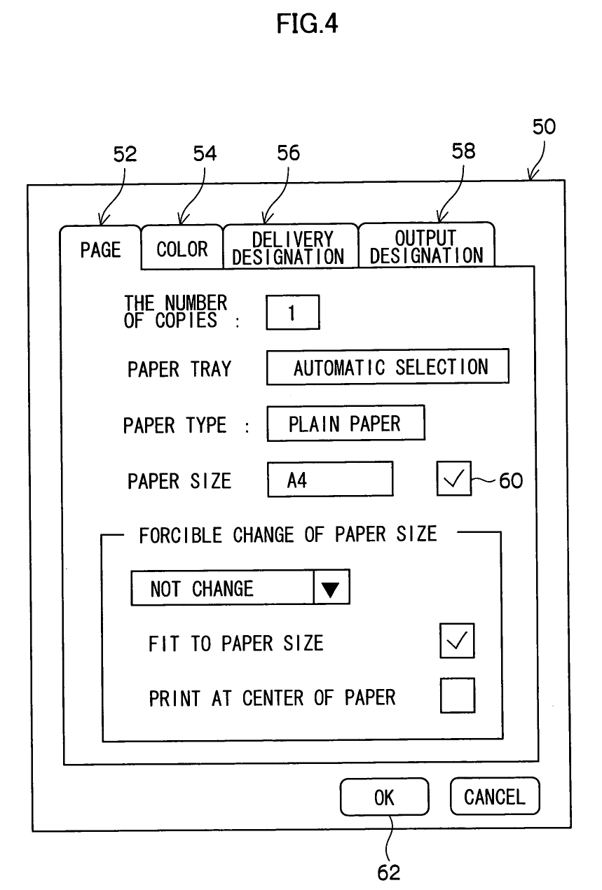

FIG. 4 shows a common setting dialogue 50 applied as an example of the user interface. In the common setting dialogue 50, a page tab 52, a color tab 54, a delivery designation tab 56, and an output designation tab 58 are set. On these tables, image processing setting (to be referred to as print options hereinafter) such as corresponding print options can be set. In FIG. 4, as an example, the page tab 52 is shown. The configuration of the user interface used in common setting is not limited to the above configuration, and an arbitrary configuration which can set predetermined print options can be applied.

On the page tab 52 of the common setting dialogue 50, “the number of copies, “paper tray”, “paper type”, and “paper size” can be set as print options. Of these options, “the number of copies”, “paper tray”, and “paper type” are set as common setting items of the connected job.

As the “paper size”, the settings of respective print jobs can also be applied. However, a check box 60 is (marked) checked, so that the “paper size” can be set as a common setting item.

In addition, on the page tab 52, a “forcible change in paper size” can be selected as a print option. As the “forcible change in paper size”, “not change” is set as a default. For this reason, settings for the respective print jobs are effective.

When a “change” is selected on a pull-down menu, the “forcible change in paper size” is set as a common setting item, and “print at center of paper” and “fitting to paper size” can be selected as common setting items.

In the print server 10, on the color tab 54, the delivery designation tab 56, and the output designation tab 58, respectively, print options set as the common setting items can be selectively set, and application of the settings of the print options of the print jobs or selection of the settings of the print options as common setting items can be set.

In FIGS. 5 to 7, as print options which can be applied in the print server 10, a print options which can be applied as only a common setting item and a print option which can apply settings of the respective print jobs are illustrated. Print options which can apply the settings of the print jobs can be selected and set as common setting items. In FIGS. 5 to 7, a single circle represents common setting items, and a double circle denotes items to which the settings of the print jobs can be applied.

As shown in FIG. 5, on the page tab 52, as described above, “the number of copies”, “paper tray”, “paper type”, and “manual double-sided printing” are set as common setting items. On the page tab 52, for print options: “change in paper size/image size”, “print at center of paper”, “fit to paper size”, the settings of the respective print jobs can be applied. The print options can also be set as common setting items. In addition, “page range” can also be applied as a common setting item, and settings of the respective print jobs can also be applied. When plural printers 18 are connected to the print server 10, “destination printer” is set as a common setting item.

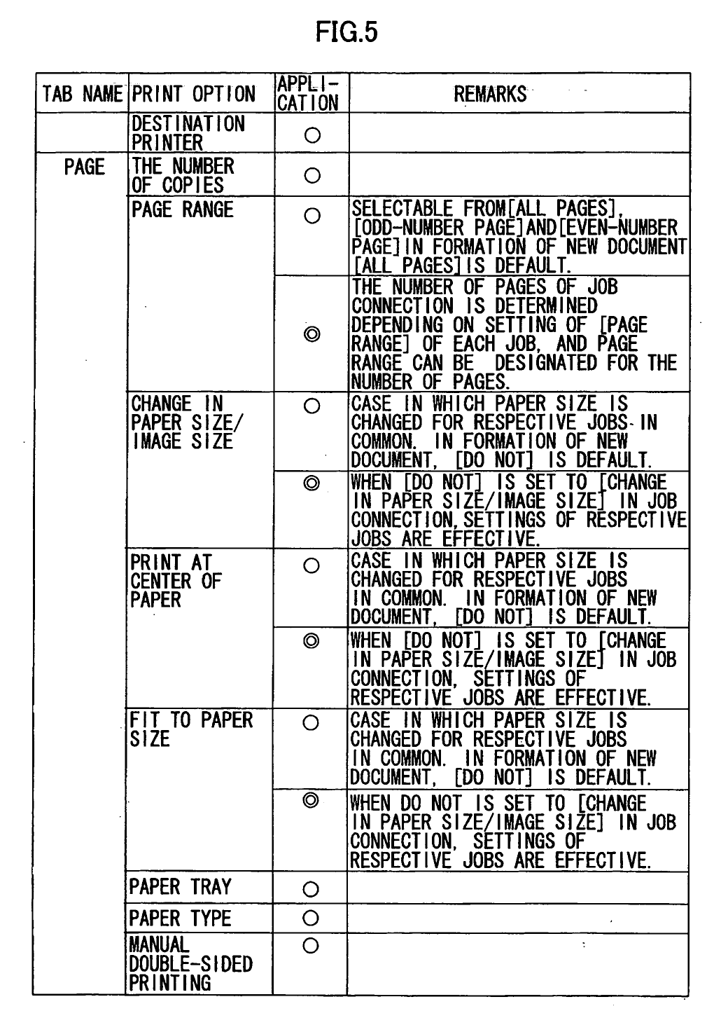

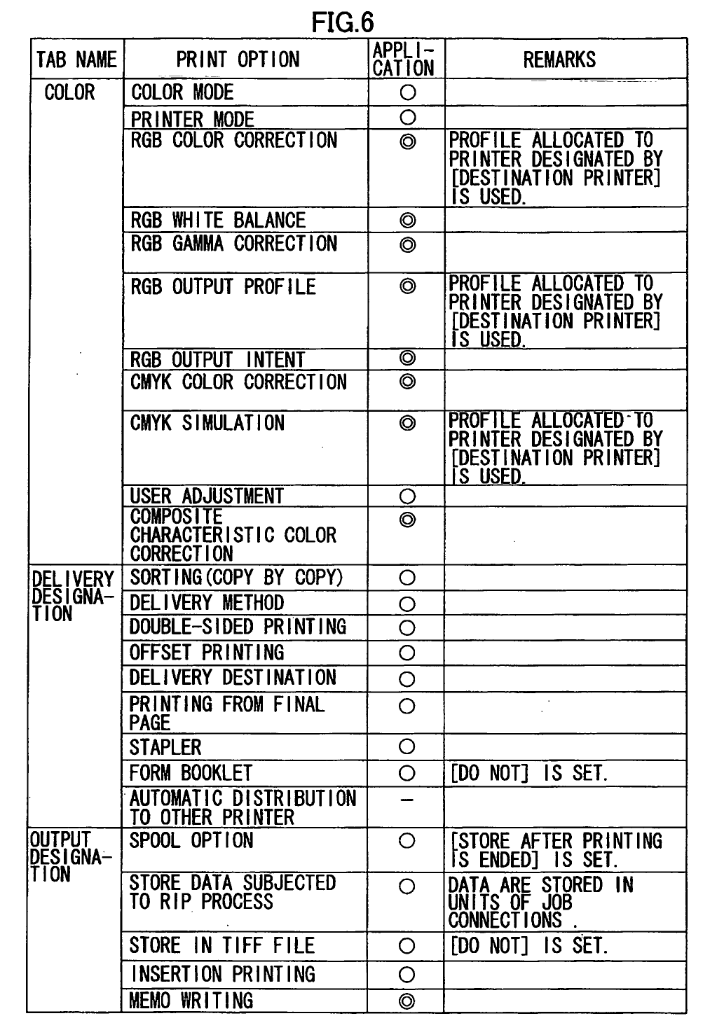

As shown in FIG. 6, on the color tab 54, print options: “color mode”, “print mode”, and “user adjustment” are set as common setting items.

On the color tab 54, for print options: “RGB color correction”, “RGB white balance”, “RGB gamma correction”, “RGB output profile”, “RGB output intent”, “CMYK color correction”, and “CMYK simulation”, settings of the respective print jobs can be applied.

On the delivery designation tab 56, print options: “do sort (copy by copy)”, “delivery method”, “double-sided printing”, “offset printing”, “delivery destination”, “printing from final page”, and “stapler” are set as common setting items. Under the condition that “paper size” or the like is set as a common setting item, “formation of booklet” may be set as a common setting item. “Automatic distribution to other printer” is not included in either the common setting items or the setting items of the print jobs (unusable).

On the output designation tab 58, “memo writing” can be applied as the settings of the print jobs, and print options: “spool option”, “storage of RIP-processed data”, “storage as TIFF file”, and “insertion printing” are set as common setting items.

The “spool option”, “storage of RIP-processed data”, “storage as TIFF file”, and the like maybe set for each connected jobs when the connected job is generated without being registered as common settings in advance.

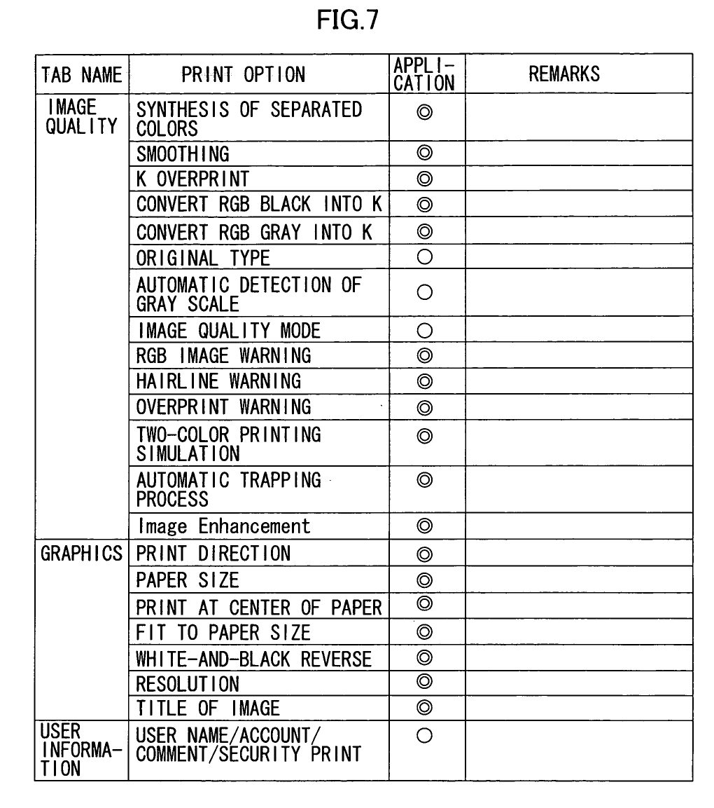

In addition, as shown in FIG. 7, when as print options related to image quality, “original type”, “automatic detection of gray scale”, and “image quality mode” are set as print options, these options are set as common setting items. When “synthesis of separated color”, “smoothing”, “K overprint”, “convert RGB black into K”, “convert RGB gray into K”, “RGB image warning”, “hairline warning”, “overprint warning”, “two-color printing simulation”, “automatic trapping process”, and “Image Enhancement” are set as print options, these print options may be able to be selected such that settings of the print jobs are applied.

When “print direction”, “white-to-black inversion”, “resolution”, and “title of image” are set as print options related to graphics, these print options may be able to be selected such that settings of the print jobs are applied.

Furthermore, when as user information, settings of a user name, an account, a comment, security printing, and the like are included in jobs, respectively, the user information may be neglected. However, it is preferable that, as a connected job, new user information can be added.

More specifically, in the print server 10, when a connected job is generated, for a print option in which settings of all pages must be integrated and a print option in which the settings are preferably integrated, a common setting is generated to be set as a common setting item.

On the other hand, in the flow chart shown in FIG. 3, a common setting item is input, and an OK button 62 on the common setting dialogue 50 (see FIG. 4) is depressed (clicked) to cause the operation to shift to step 104.

In this step 104, a common setting name is input on a registration screen, and a registration button is operated on the registration screen to determine affirmative in step 106. The operation shifts to step 108 to store the common setting name is stored (registered) in the memory 46 as a common setting when a connected job is generated. For example, when “common setting 1” is input as the common setting name, “common setting 1” is registered in the memory 46.

In the print server 10, when the common setting is registered in advance as described above, a connected job using the common setting can be generated. As a registration screen, a user interface having an arbitrarily configuration can be applied.

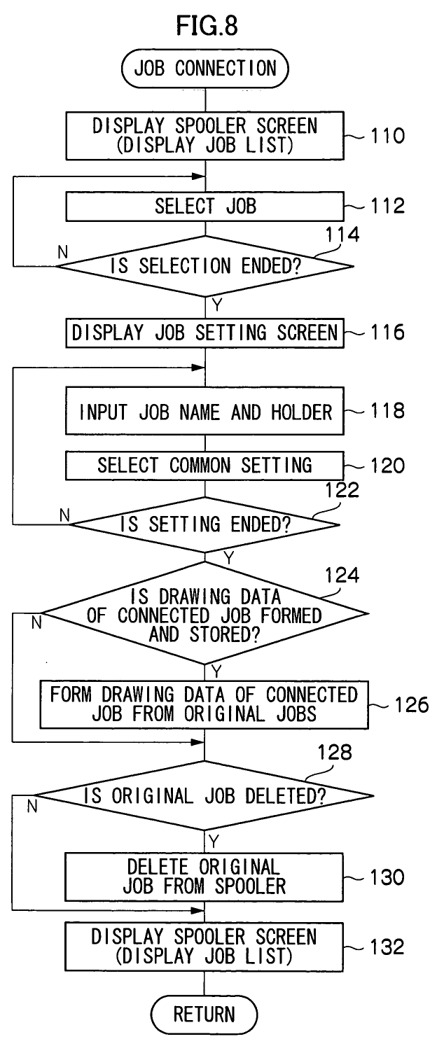

FIG. 8 shows an example of a job connection process. This flow chart is executed such that job connection is selected on the menu screen displayed on the display device 22. In the first step 110, a list (job list) of print jobs held in the spooler 40 is displayed on the display device 22. Print jobs held in the spooler 40 include a print job set to be held by the client terminal 14 and then transmitted and a print job which is designated to wait for a process such as waiting for printing processing.

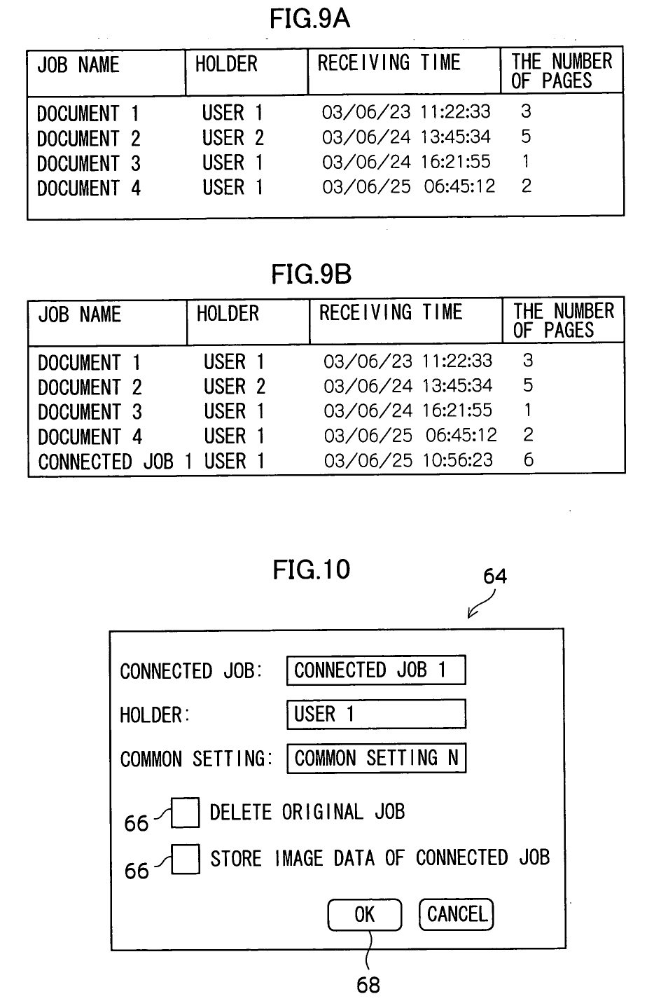

FIG. 9A shows a display, which is an example of a display of a job list, obtained when four print jobs “document 1” to “document 4” are held.

In step 112 of the flow chart shown in FIG. 8, print jobs to be connected are selected from the job list. For the selection of print jobs to be connected, an arbitrary method such as a method of moving a cursor or a drag-and-dropping method can be applied. When the print jobs are to be selected, a connection order is also selected.

In the next step 114, it is checked whether the selection of print jobs is finished or not. When the selection of the print jobs to be connected is finished, the determination is affirmative in step 114 to cause the operation to shift to step 116, and a user interface for setting a connected job is displayed.

FIG. 10 shows a connected job setting dialogue 64 as an example of the user interface. In the connected job setting dialogue 64, a connected job name, a holder (user name), a common setting name to be applied can be input.

At this time, an arbitrary method such as the following method can be applied. That is, common setting names registered in advance and stored in the memory 46 are displayed by a pull-down menu or the like, the common setting names are selected on the display.

In the connected job setting dialogue 64, print options: “delete original job” and “store image data of connected job” which are set as common setting items can be set. In the setting of the print options, an arbitrary method, which marks a corresponding check box 66, can be applied.

In the flow chart in FIG. 8, a job name and a user name are input by using the connected job setting dialogue 64 in step 118, and a common setting is selected in step 120. At this time, selective setting to a preset common setting item is also performed.

Thereafter, the setting is ended, an OK button 68 on the connected job setting dialogue 64 shown in FIG. 10 is operated, and the determination is affirmative in step 122 in FIG. 8 to cause the operation to shift to step 124.

In step 124, a setting for determining whether drawing data (image data) of the generated connected job is formed and stored or not is confirmed. More specifically, on the check box 66 in FIG. 10, it is confirmed whether “store image data of connected job” is selected or not.

In this case, when “store image data of connected job” is selected, the determination is affirmative in step 124 to cause the operation to shift to step 126. In this step 126, image data of print jobs held in the spooler 40 are connected in a set order to generate image data of the connected job, and the generated image data of the connected job is held in the spooler 40.

In step 128, it is confirmed whether the image data of the original print jobs is deleted or not. More specifically, it is confirmed whether “delete original job” is selected or not on the connected job setting dialogue 64 in FIG. 10.

In this case, when “delete original job” is selected, the determination is affirmative in step 128, and the operation shifts to step 130. In step 130, the image data of the print job held in the spooler 40 is deleted.

Upon completion of the generation of the connected job as described above, the operation shifts to step 132 to display a spooler screen. More specifically, a job list held by the spooler 40 is displayed.

FIG. 9B shows an example of a job list obtained upon completion of job connection. This job list shows a state in which documents 1, 3, and 4 are connected to generate a connected job 1.

At this time, when “delete original job” is not selected, a state in which the job ID, image data (drawing code), and the image processing setting of the “documents 1, 3, and 4” serving as original jobs (print jobs) are stored. When “delete original job” is selected, the documents 1, 3, and 4 are deleted, and “document 2” and “connected job 1” are displayed in the job list.

When “store image data of connected job” is not selected, the image data of the connected job is not held in the spooler 40, and a selected common setting and connection information representing print jobs to be connected, a connection order of the print jobs, and the like are stored in the spooler 40.

In addition, when “store image data of connected job” is selected, the generated image data of the connected job and the selected common setting are stored in the spooler 40.

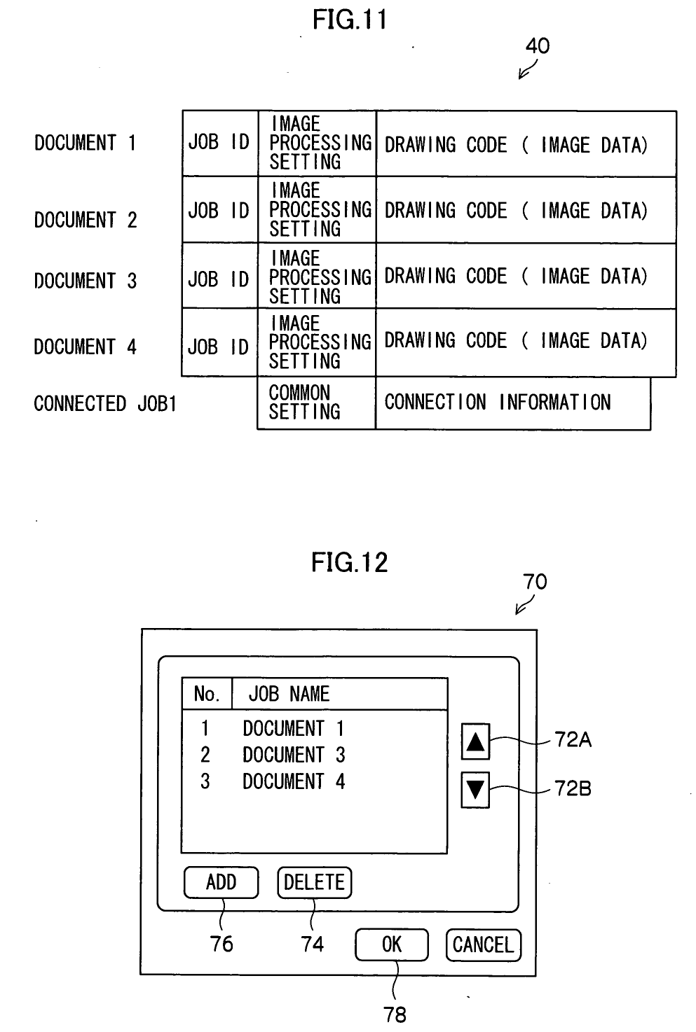

More specifically, as shown in FIG. 11, in the spooler 40 in a state in which “delete original job” and “store image data of connected job” are not set, in addition to “job ID”, “image processing setting”, and “drawing code (image data)” of document 1 to document 4, “common setting” and “connection information” representing that documents 1, 3, and 4 are connected are simply stored as connected job 1.

Therefore, an amount of data of a connected job is considerably smaller in this case than the case in which the image data of the connected job is stored in the spooler 40.

On the connected job setting dialogue 64 shown in FIG. 10, when “delete original job” is selected without selecting “store image data of connected job”, a warning is generated to urge a user to change the setting. In this manner, the spooler 40 is prevented from being set in a state in which the image data of the connected job is not stored.

As described above, when “store image data of connected job” is not set, the connection component 44 arranged in the print server 10 generates connection information formaking the selected print jobs and the order of the print jobs clear and common settings stored in the memory as a connected job. When the print process is designated, the image data of the print jobs stored in the spooler 40 is used as the image data of the connected job.

On the other hand, in the print server 10, when “delete original job” is not selected, the selected print jobs (image data of the print jobs) are not deleted from the spooler 40. More specifically, since the original print jobs are left in the spooler 40, even though the connected job is edited, the original print jobs can be reliably prevented from being lost from the spooler 40 without performing a cumbersome process of reproducing the original print jobs from the connected job.

For this reason, in the print server 10, as a matter of course, addition of a new print job to the connected job and editing of the connected job such as deletion of a selected print job from the connected job can be easily performed. Even though a print job is added, an amount of data stored in the spooler 40 can be prevented from largely increasing.

FIG. 12 shows an editing dialogue 70, which is an example of a user interface for editing a connected job. In the editing dialogue 70 of the connected job, a list of print jobs constituting the connected job is displayed. With an operation of an up key 72A and a down key 72B, print jobs are selected. Thereafter, with an operation of a delete key 74, a selected print job is deleted from the connected job.

At this time, when the original jobs are stored in the spooler 40, a print job can be deleted from the connected job by only changing the connection information of the connected job. For this reason, a process of deleting a print job constituting the connected job is very easy.

When a new print job is added to the connected job, an addition button 76 on the editing dialogue 70 is operated.

In this manner, the job list of the print jobs stored in the spooler 40 is displayed on the display device 22 together with the editing dialogue 70. In this state, for example, a drag-and-dropping operation is performed to move a print job in the job list onto the editing dialogue 70. When the drag-and-dropping operation is performed such that the added print job has a desired turn, the new print job is added to the connected job.

As described above, editing such as addition and deletion of a print job is ended, and an OK button 78 on the editing dialogue 70 is operated to cause the connection component 44 to change the connection information.

In the print server 10, the connected job can be generated and edited by only a simple process of changing connection information.

[Second Embodiment]

In the print server 10, by using the spooler 40, a process for a print job to which security is set can also be performed. The connection component 44 can also connect print jobs to which security is set.

As the second embodiment, job connection including a print job to which security is set will be described below.

The print job to which security is set is transmitted from the client terminal 14 such that a password is set. When the print server 10 receives the print job, the print server 10 holds the print job in the spooler 40.

When a process (print process) to the print process is designated, a job list held in the spooler 40 is displayed on the display device 22, and a corresponding print job is selected on the job list to display a password input screen. A password is input on the password input screen. When the input password is correct, a process (print process) to the print job is executed.

As the process to the print job to which security is set, a process having an arbitrary configuration can be applied. A detailed description thereof will be omitted in the second embodiment.

As shown in FIG. 7, in the print server 10, a print option such as security printing is designed to be set as a common setting item.

The connection component 44 arranged in the print server 10 confirms whether security is set to a selected print job or not when a connected job is generated. When the security is set, a password is requested to be input. When the input password coincides with the set password, the corresponding print job is selected.

The connection component 44 sets a password to a generated connected job when security is set to any one of the selected print jobs. More specifically, security is set to the connected job including the print job to which security is set, so that the print job to which security is set is protected.

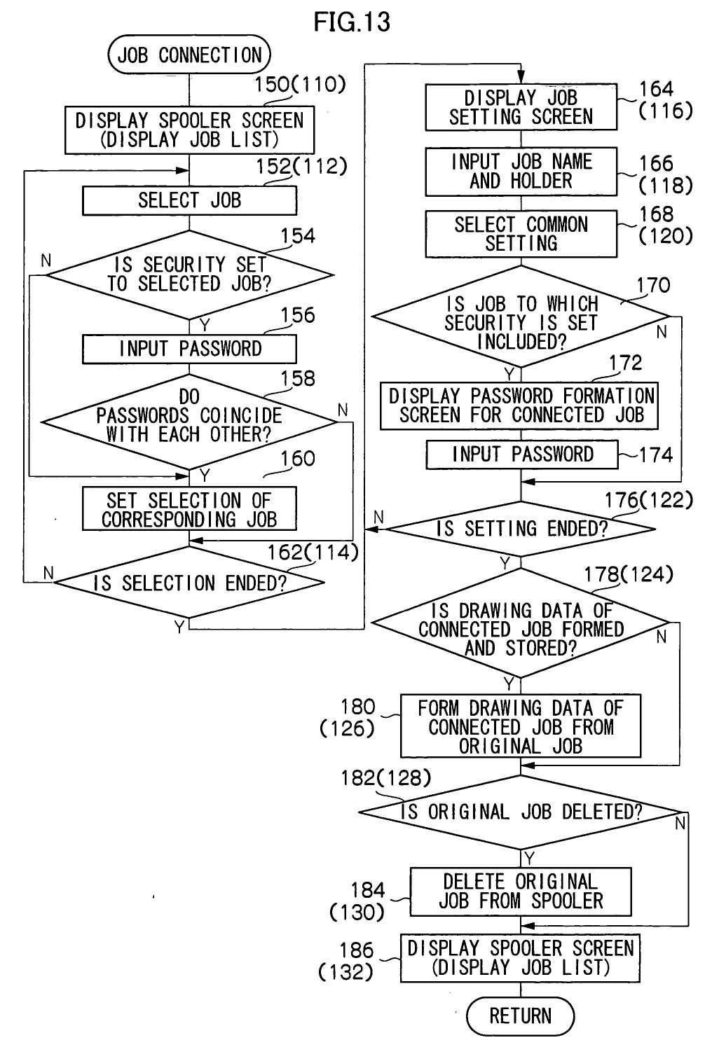

The second embodiment will be described below with reference to FIG. 13. In the flow chart in FIG. 13, a flow of job connection according to the second embodiment. The same step numbers as in the flow chart in FIG. 8 applied to the first embodiment denote the same processes in the flow chart in FIG. 13, and a description thereof will be omitted.

This flow chart is executed by selecting job connection on a menu screen, job lists of print jobs held in the spooler 40 is displayed in the first step 150, and print jobs to be connected are selected in step 152.

Thereafter, in step 154, it is confirmed whether security is set to the selected print jobs or not. When the security is set, the determination is affirmative in step 154 to cause the operation to shift to step 156, and a password is requested to be input. For the input request of the password, an arbitrary user interface can be applied.

When the password is input, the operation shifts to step 158 to confirm whether the input password coincides with the password set in the print job or not. When the passwords coincide with each other, the determination is affirmative in step 158 to cause the operation to shift to step 160, and selection of the corresponding print job is set. More specifically, the corresponding print job is authenticated as a selected print job.

In contrast to this, when the passwords coincide with each other, the operation shifts to step 162 without selecting the corresponding print job.

In this manner, upon completion of the selection of a desired print job, when the determination is affirmative instep 162, the operation shifts to step 164 to display the connected job setting dialogue 64. When input of a job name and a holder (step 166) and selection of a common setting (step 168) are performed, the operation shifts to step 170 to confirm whether the connected job includes a print job to which security is set or not.

In this case, when the connected job do not include a print job to which security is set, the determination is negative in step 170 to cause the operation to shift to step 176.

In contrast to this, when the connected job includes a print job to which security is set, the determination is affirmative in step 170 to cause the operation to shift to step 172. In the step 172, a password creating screen for a connected job is displayed.

In this manner, when a password is input in step 174, the operation shifts to step 176 to confirm whether the setting of the connected job is ended or not.

More specifically, when the print jobs in the generated connected job includes a print job to which security is set, security is set to the connected job including the print job.

As the password, the password for the print job may be used, or a new password set for the connected job may be used. When the password is set, the determination is affirmative in step 176. When formation of drawing data of the connected job is set, the drawing data of the connected job is formed (steps 178 and 180). When deletion of an original print job is set, the original print job is deleted (steps 182 and 184), and a job list is displayed (step 186).

In this manner, in the print server 10, when a connected job is generated by using a print job to which security is set, security is also set to the connected job. For this reason, the connected job can be reliably prevented from being arbitrarily accessed.

The embodiments as described above are not limited the configuration of the invention. For example, in the embodiments, the print server 10 is exemplified as an image processing apparatus. However, the invention can be applied to not only the print server 10 but also an image processing apparatus such as an intermediate server which has an arbitrary configuration and to which a process job such as a print job from an image processing terminal such as a client terminal is input.

1. An image processing apparatus comprising:
a memory that stores a job including image data output from an image processing terminal and an image processing setting;
an image processing component that performs predetermined image processing to the job stored in the memory;
a job connection component that sets connection information for connecting plural jobs and a print setting condition of a connected job when the jobs stored in the memory are selected and generation of the connected job is instructed; and
a print process execution component that executes a print process of the connected job based on the connection information and the print setting condition set by the job connection component.

2. The image processing apparatus of claim 1, wherein the job connection component stores the connection information and the print setting condition as a connected job in the memory.

3. The image processing apparatus of claim 1, further comprising a generation component that generates image data of the connected job based on the image data of the plurality of selected jobs.

4. The image processing apparatus of claim 1 further comprising a deleting component that deletes the plural selected jobs from the memory.

5. The image processing apparatus of claim 3 further comprising a deleting editing component that deletes a selected job from the connected job generated by the generation component and stored in the memory.

6. The image processing apparatus of claim 3 further comprising an addition editing component that adds a new job to the connected job generated by the generation component and stored in the memory.

7. The image processing apparatus of claim 1 further comprising a storage component that stores the image processing setting for the preset connected job as a common setting, wherein the job connection component selects the common setting stored in the storage component as an image processing setting of the connected job.

8. The image processing apparatus of claim 7, wherein the common setting stored in the storage component includes common setting items, which are applied to the plural jobs to be connected.

9. The image processing apparatus of claim 1, wherein, when a password is set for a selected job stored in the memory, and, when a password which coincides with the set password is input, the job connection component sets the job as a job to be connected.

10. The image processing apparatus of claim 9, wherein, when the selected job includes a job for which a password is set, the job connection component sets a password for the generated connected job.

11. An image forming apparatus comprising:
a memory that stores a print job including image data output from an image processing terminal and a print setting condition;
an image processing component that performs predetermined image processing to the print job stored in the memory;
a print job connection component that sets connection information for connecting plural print jobs and a print setting condition of a connected job by selecting the print jobs stored in the memory and instructing generation of the connected job; and
a print process execution component that executes a print process of the connected job on based on the connection information and the print setting condition set by the print job connection component.

12. The image forming apparatus of claim 11, wherein the print job connection component stores the connection information and the print setting condition as a connected job in the memory.

13. The image forming apparatus of claim 11 further comprising a generation component that generates image data of the connected job based on the image data of the plurality of selected print jobs.

14. The image forming apparatus of claim 11 further comprising a deleting component that deletes the plurality of selected print jobs from the memory.

15. The image forming apparatus of claim 13 further comprising a deleting editing component that deletes a selected print job from the connected job generated by the generation component and stored in the memory.

16. The image forming apparatus of claim 13 further comprising an addition editing component that adds a new print job to the connected job generated by the generation component and stored in the memory.

17. The image forming apparatus of claim 11 further comprising a storage component that stores the image processing setting for the preset connected job as a common setting, wherein the print job connection component selects the common setting stored in the storage component as an image processing setting of the connected job.

18. The image forming apparatus of claim 17, wherein the common setting stored in the storage component includes common setting items which are applied to the plural print jobs to be connected.

19. The image forming apparatus of claim 11, wherein, when a password is set for a selected print job stored in the memory, and, when a password which coincides with the set password is input, the print job connection component sets the print job as a print job to be connected.

20. The image forming apparatus of claim 19, wherein, when the selected print job includes a print job for which a password is set, the print job connection component sets a password for the generated connected job.
